(19) United States
(12) Patent Application Publication
(10) Pub. No.: US 2011/0038625 A1
(43) Pub. Date: Feb. 17, 2011

(54) ELECTROMECHANICAL POLYMER ACTUATORS

(75) Inventors: Brian Zellers, State College, PA (US); Shuxiang Dong, Beijing (CN); Shihai Zhang, State College, PA (US); Qiming Zhang, State College, PA (US)

Correspondence Address: Gifford, Krass, Sprinkle, Anderson & Citkowski,;P.C., Suite 330, 2701 Troy Center Drive, Post Office Box 7021, Troy, MI, 48007-7021, US

(73) Assignee: Strategic Polymer Sciences, Inc., State College, PA (US)

(21) Appl. No.: 12/856,035

(22) Filed: Aug. 13, 2010

Related U.S. Application Data
(60) Provisional application No. 61/233,528, filed on Aug. 13, 2009.

(51) Int. Cl. G03B 13/34; G02B 7/02

(52) U.S. Cl. 396/133; 359/824

(57) ABSTRACT

An adaptive lens comprises an actuator and a lens, the lens being mechanically coupled to the actuator so that energization of the actuator adjusts a focal point of the lens. The actuator may comprise a multilayer stack of electromechanical polymer (EMP) layers, having electrodes configured to apply an electric field across each EMP layer. The actuator may be operable to move and/or deform a lens, so as to adjust the focus properties of the lens. In some examples, the actuator has an annular shape, supporting a lens within the inner radius of the annulus. The lens position may be adjusted in an axial direction. In other examples, the actuator may be mechanically coupled a surface of a deformable lens, either directly or through another element of a lens structure. A strain applied to the lens modifies a curved surface of the lens, hence modifying the focal length of the lens.

### REFERENCE TO RELATED APPLICATION

This application claims priority from U.S. Provisional Application Ser. No. 61/233,528, filed Aug. 13, 2010, the entire content of which is incorporated by reference.

### FIELD OF THE INVENTION

The present invention relates to actuators, in particular to actuators including an electromechanical polymer, including auto-focus systems.

### BACKGROUND OF THE INVENTION

Autofocus systems find uses in many different types of camera systems. The autofocus system is typically a closed loop control of the focusing lens contained in the system. The autofocus system goal is to optimize the level of sharpness of the focused image by translating the focus lens either closer to or farther away from the focus image.

There are two types of autofocus technology, labeled active and passive. An active autofocus uses a signal echo to determine the distance from the focus lens to the target image. This distance information is used to determine the position of the focus lens in the autofocus system, where the position of the focus lens is controlled by some type of mechanical power source (i.e. an electric motor).

Passive autofocus uses a dedicated number of pixels in the optical sensor array, referred to as the capture array, to determine the image sharpness. Here, the gradient of image data between adjacent pixels in the capture array is computed and analyzed to determine the sharpness of the image. The focus lens is then translated and again the capture array data is analyzed to determine the sharpness of the image and is compared to previous sharpness data based on focus lens location. This iterative process continues until the optimal focus lens position is determined, at which point the camera system is ready to capture the target image. See US 2006/0092311.

The challenge that is encountered in using autofocus technologies is in applications where space and power are at a premium, as in cellular phone applications and other portable consumer electronics that are powered by battery. Specifically, the challenge is to design systems that can fit into extremely small volumes of space, consume little power to actuate the focus lens, maintain a level of shock resistance consistent with adjacent components (a concern for handheld devices), and be easy to implement. Possible candidate technologies that have been conventionally used for such applications are electric motors (stepper or servo), piezoceramic materials, and voice coil motors (VCM).

Considering motors, they require an architecture that is too large to meet the small volume demanded by evolving handheld battery powered consumer technologies. Piezoceramic materials lack the shock resistance due to their brittle material property. Owing to their small displacement under an applied voltage, they require motion accumulation mechanisms adding to the complexity of the design. VCMs are a technology present in hard drives where they move the read/write head of the hard drive. Although they can provide high spatial precision and resolution with a large frequency response, they do require a large amount of power when considering battery powered cellular phone applications. In addition, VCM designs require a holding spring to maintain the focus lens adjustment, adding to their complexity and size.

One approach uses inflating bubble technology (US 2006/0092311). In this design, a bed of small volume bubbles are inflated and deflated to perform the actuation. Here, the optical sensor array sits atop the bubble array, which itself is covered by an elastic membrane. When the capture array determines a need to move the optical sensor array, heating wires transfer heat to the bubbles. This heat transfer heats either a gas or liquid, causing it to expand thereby increasing the diameter of some or all of the bubbles. These bubbles in turn move the optical sensor array, and hence the capture array, with respect to the focus lens, which is fixed to mechanical ground. In this case, the focus lens remains fixed and the optical sensor array translates according to the iterative analysis that optimizes the image sharpness.

In another approach, a compliant membrane surrounds a skeletal structure. The compliant membrane contains both the skeletal structure and an optical fluid (US 2007/0030573). The entire structure, including the membrane, the internal skeleton, and optical fluid, are in the shape of a cylinder, where light is able to pass through the circular ends of the cylinder-like structure. Around the circumference of the cylinder is an actuator (i.e. a shape memory alloy or the like) that contracts around the cylinder. This contraction of the circumference of the actuator squeezes the compliant membrane increasing the internal pressure. The reaction to the increase in pressure is an outward deflection of the circular ends of the cylinder. At this point, the once planar circular ends are now convex and out of the plane of their unpressurized state. The change in curvature of ends of the cylinder, when under pressure from the contracting circumferential actuator, yields a corresponding change in the refractive index of the light which passes through it.

In another approach, a stepper-like motor with a stator and rotor is employed to drive the focus lens along its optical axis via a helicoidal type screw (U.S. Pat. No. 7,206,145). By zeroing the position of the focus lens, the pulses in the pulse train that drives the stepper-like motor are counted in total to derive the position of the lens. The focus lens position is zeroed by using a single photo gate system where a light emitting and a light receiving element are position in parallel fixed to mechanical ground. The corresponding reflective element is held on the circumference of the focus lens, and when in the zero position, will complete the photo gate circuit. This design can generate quite large displacements, however, its size is quite large due to the complex mechanical design.

Therefore, improved actuators for autofocus systems with compact size and low energy consumption are urgently required, in particular for portable electronic devices such as cameras and cellphones.

### SUMMARY OF THE INVENTION

Examples of the invention include electromechanical polymer (EMP) actuators, in particular EMP actuators used in the autofocus mechanism of a lens. An EMP actuator may include one or more electromechanical polymer (EMP) layers, for example as a multilayer structure, and may further include one or more additional electromechanical and/or non-electroactive layers. Each EMP layer has associated electrodes configured to apply an electric field so as to obtain actuation. An EMP polymer provides a mechanical response on application of an electrical field to the EMP.

Examples of the present invention include a multilayer electromechanical polymer (EMP) actuator, and include an actuator-driven adaptive lens. The EMP portion of the multilayer may be a generally annular shape with a uniaxial or biaxial orientation, or a generally circular shape with a uniaxial or biaxial orientation. In some examples, a multilayer EMP actuator may deflect radially when energized.

An EMP layer can be preprocessed (i.e. uniaxially or biaxially stretched, electroded, etc.) to improve the layer's electromechanical response to applied external fields. Preprocessing, such a stretching, can be used to control the direction(s) of actuation.

In a multilayer actuator, a plurality of EMP layers with associated positive and negative electrodes are stacked together. The EMP layers and electrode layers may be bonded together into a multilayer stack actuator. The EMP layers may be in parallel, and separated by electrodes and optionally by additional passive layers adjacent the EMP layers. Each EMP layer may share one electrode with a neighboring EMP layer, allowing the one electrode to provide an electric field to the layers located above and below the electrode. Preferably, the passive layer has an elastic modulus equal or greater than that of the EMP layer.

Examples of the present invention include the use of EMP actuators to provide micro-level articulation of a lens. An autofocus EMP articulated lens can be an extremely thin design, for example less than 2 mm in thickness, small size (e.g. less than 20 mm diameter), shock resistant, and simple to construct. Such a design lends itself to a very reliable and inexpensive device. Example applications include autofocus systems for optical lenses in various camera applications, including cellphone cameras.

A lens (for example, of an autofocus system) can be rigidly attached (e.g. directly bonded) to an EMP actuator. Actuation may occur using lens supports included in the actuator, and the lens support points may be proximate a free end (e.g. at the tips) of EMP segments or layers.

In another system, an EMP actuator can be directly bonded to a frame, such as a hinged frame, that holds the lens. In a framed system, hinged ends allow for a pinned boundary condition. Example applications include autofocus systems for optical lenses in various camera applications.

In some examples, the lens is part of a lens structure, which may further include a flange about the circumference of the lens structure suitable for bonding an actuator, such as a multilayer actuator. A lens structure can comprise any transparent highly elastic solid material. In some examples, a portion of the lens structure is a flat surface suitable for bonding to an actuator, such as a multilayer actuator. The lens structure may comprise different transparent highly elastic solid materials bonded together, for example as a multilayer.

The actuator may adjust the position of a lens, e.g. the position of a lens relative to an imaging device. The electromechanical response of one or more EMP layers is mechanically coupled to the lens, so that the lens position changes in a manner correlated with the applied electric field. In some examples, differential expansion of the EMP layer(s) relative to passive layer(s) is used to obtain the lens movement.

In other examples, the lens comprises an elastic material, such as a rubber, in particular a silicone rubber. The actuator applies a force to the lens (or other component of an associated lens structure that is mechanically coupled to the lens) so as to deform the lens. For example, the radius of curvature of a curved face of the lens may vary as a function of the electric field applied to an actuator.

Hence, actuators can be used to optimize the focus of an image formed by the lens. Actuated lenses according to examples of the present invention can be used with any autofocus approach, such as passive or active autofocus approaches.

Examples of the present invention include a multilayer EMP actuator driven autofocus lens system. An actuator may comprise a single layer or multilayers of EMP polymer, or other electromechanical material. An EMP actuator may be bonded or otherwise attached to a frame.

In some examples, the actuator includes EMP layers formed in the shape of an annulus. An EMP annulus-shaped layer may be bonded to an adjacent passive layer (sometimes referred to as a shim layer), which may also be in the form of an annulus. The EMP annulus may be divided into a plurality arcuate active segments, and may be attached to a frame. An active segment may have one or more free ends, and may be attached to a frame at one or more support points.

The passive layer may comprise a metal such as phosphor copper, other metal, polymer, or other material. A polymer used in a passive layer preferably has a glass transition temperature higher than 200° C. Preferably, the electromechanical response of the EMP layer is substantially greater than that of the passive layer, so that differential expansion or contraction occurs between passive and EMP layers as a field is applied to the EMP layers.

A multilayer EMP can be formed in the shape of bimorph actuator mounted on a frame. The number of bimorph actuators in the autofocus lens system can be two or more than two, preferably three. A multilayer EMP unimorph actuator can be bonded on a frame. The number of multilayer EMP unimorph actuators can be two or more, and is preferably three. In a unimorph actuator, the multilayer EMP may be bonded to a substrate. The substrate can be, but is not limited to, phosphor copper or a polymer, and the polymer is preferably has glass transition temperature higher than 200° C.

An EMP film can be uniaxially stretched and in fabricating the EMP actuator, the uniaxial stretching direction may be generally along a circumferential direction of the actuator. A film can be uniaxially stretched, and then a portion of the annulus shape can be cut from this uniaxially stretched film. Here, the portion of the annulus shape would be aligned such that longest dimension of this shape would be parallel to the stretched axis of the EMP film. The EMP layer can be configured to maximize all displacement vector components of the electromechanical response to the applied field, along the circumferential direction. In various examples, the EMP films can be in a non-stretched form, uniaxially stretched, or biaxially stretched.

In another example, the electromechanical annulus is divided into a plurality of active segments (which may be referred to as just “segments”), for example, symmetrically divided into two or more segments. An active segment includes at least one EMP layer, and electrodes configured to actuate the segment. Each segment may be cantilevered from an actuator support point, for example a raised section of the base, or other protrusion from a supporting frame. The number of actuator support points may equal the number of annular segments, so that each segment is attached to the base by one support point. When actuated by an electrical signal, a free end of the cantilevered segment displaces, and this movement can be mechanically transferred to a movement of the lens.

In particular examples, the electromechanical annulus is symmetrically divided into three segments. Each segment is then cantilevered from one of the three raised radial sections of the base. In some examples, the fixed point of these cantilevered segments occurs along a radial line which bisects the electromechanical annulus segment. As such, the resulting displacement of the electromechanical annulus segment results in a “gull wing” like shape as indicated in the displacement schematic, each segment then having two free ends which may be attached to the lens. Alternatively, the fixed point of the cantilevered segments may be proximate one end of the segment, the other end being a free end.

In some examples, multiple electromechanical actuators, such as electromechanical annuluses, can be stacked together, for example as three electromechanical annulus stacks, so as to achieve a cumulative displacement.

Examples of the present invention include a multilayer electromechanical polymer (EMP) actuator driven adaptive lens, where the EMP portion of the multilayer can be a continuous or divided annular shape with a uniaxial or biaxial orientation of the polymer. The EMP of the multilayer can be a continuous circular shape with a uniaxial or biaxial orientation.

The electrodes used to apply the electric field to the EMP layers (e.g. within a multilayer actuator) can be any electrically conducting material, such as a metal or electrically conductive polymer. Preferably, the electrically conducting material is capable of being deposited on the EMP with a resulting thickness of less than 100 μm. The electrodes for the EMP portion of the multilayer can be any transparent conductive material such as, but not limited to, indium tin oxide (ITO), for example with a resulting thickness of less than 100 μm.

The electrodes for the EMP portion of a multilayer actuator can be any transparent conductive material such as a conducting polymer or transparent conducting oxide. A non-limiting example is indium tin oxide (ITO). The electrode thickness may be less than 100 μm.

In some examples, a multilayer EMP actuator deflect radially when energized. In this context, the radial direction may be perpendicular to the optic axis of the lens, and may be within the plane of a generally disk-shaped actuator.

The lens may comprise any transparent highly elastic solid material, and may be part of a lens structure adapted to be mechanically coupled to the actuator. A lens structure may include a flange (e.g. disposed about the outer circumference of the lens structure) suitable for attaching the lens to the actuator, or element providing a surface that may be attached to an actuator.

In some examples, the lens structure may include a surface, such as a flat surface, suitable for bonding to an adjacent multilayer actuator. The actuator may apply a stress or strain force to the surface, inducing a shape change of the lens. The lens structure may include a multilayer of different transparent highly elastic solid materials bonded together. For example, the actuator may be bonded to a planar surface of a disk-shaped element, with a lens bonded to the opposite surface of the disk-shaped element. A force applied to the disk then is conveyed to the lens.

In some examples, the actuator is generally transparent at the operating wavelengths of the lens. Hence, for the first time, the actuator can be placed within the light path, and may be placed between the lens and an associated imaging device. This allows miniaturization of the lens assembly without the usual problems of light blockage by the autofocus system components. Further, in display and projection applications, individual pixel focusing is possible with greatly reduced loss in brightness. Even if there is some light loss through the actuator, overall light throughput can be enhanced as the available lens aperture is maximized for the available space.

An EMP (electromechanical polymer) layer may comprise one or more polymers, such as a polymer selected from: P(VDFₓ-TrFE_{y}-CFE_{1-x-y}) (VDF: vinylidene fluoride, CFE: chlorofluoroethylene, x and y are monomer content in molar), P(VDFₓ-TrFE_{y}-CTFE_{1-x-y}) (CTFE: chlorotrifluoroethylene), poly(vinylidene fluoride-trifluoroethylene-vinylidede chloride) (P(VDF-TrFE-VC)), poly(vinylidene fluoride-tetrafluoroethylene-chlorotrifluoroethylene) (P(VDF-TFE-CTFE)), poly(vinylidene fluoride-trifluoroethylene-hexafluoropropylene), poly(vinylidene fluoride-tetrafluoroethylene-hexafluoropropylene), poly(vinylidene fluoride-trifluomethylene-tetrafluoroethylene), poly(vinylidene fluoride-tetrafluoroethylene-tetrafluoroethylene), poly(vinylidene fluoride-tri fluoroethylene-vinyl fluoride), poly(vinylidene fluoride-tetrafluoroethylene-vinyl fluoride), poly(vinylidene fluoride-trifluoroethylene-perfluoro(methyl vinyl ether)), poly(vinylidene fluoride-tetrafluoroethylene-perfluoro(methyl vinyl ether)), poly(vinylidene fluoride-trifluoroethylene-bromotrifluoroethylene, polyvinylidene), poly(vinylidene fluoride-tetrafluoroethylene-chorofluoroethylene), poly(vinylidene fluoride-trifluoroethylene-vinylidene chloride), and poly(vinylidene fluoride-tetrafluoroethylene vinylidene chloride), or in a general form of P(VDFₓ-2nd monomer_{y}-3rd monomer_{1-x-y}) where x can be in the range from 0.5 to 0.75, and y in the range 0.45 to 0.2. Example polymers are also described in U.S. Pat. No. 6,787,238.

An EMP can also be selected from the high energy irradiated P(VDFₓ-TrFE₁₋ₓ) copolymers, where x can be varied from 0.5 to 0.75. Example materials are described in U.S. Pat. Nos. 6,423,412 and 6,605,246. The EMP can be a blend of one or more terpolymer with one or more other polymers.

An example improved autofocus mechanism comprises an actuator including an electromechanical polymer (EMP) layer, an optional passive layer adjacent the electromechanical polymer layer, electrodes configured to apply an electric field across an electroded portion of the electromechanical polymer layer, so as to induce an electromechanical response in the electroded portion of the electromechanical polymer layer. The passive layer, if present, preferably has no appreciable electromechanical response to the electric field. Actuation may then result from the difference in the mechanical responses of the EMP layer and the passive shim layer.

Actuators according to examples of the present invention can be used with any autofocus technology to obtain an improved autofocus camera. Such cameras may be portable cameras, or any other portable electronic device (such as a cellphone) including an autofocus camera.

### BRIEF DESCRIPTION OF THE DRAWINGS

FIGS. 1A and 1B show the electromechanical response of a P(VDF-TrFE-CFE) terpolymer.

FIG. 1C shows an example EMP actuator configuration.

FIGS. 2A-2D show bending of an EMP unimorph actuator.

FIGS. 3A-3C illustrate an autofocus EMP actuator.

FIG. 4 shows the deflection prediction of the multilayer electromechanical polymer annulus.

FIGS. 5A and 5B show an example electrode pattern on the top and bottom of a single EMP layer.

FIGS. 6A-6C shows the location of the lens as it is fixed to the inner diameter of an electromechanical annulus.

FIGS. 7A and 7B show an electromechanical annulus symmetrically divided into three arcuate segments.

FIGS. 8A-8C show an electromechanical autofocus lens using six cantilever segments.

FIG. 9 shows displacement of an annulus having three support positions.

FIGS. 10A-10D illustrate a stacked configuration of active EMP annuluses that achieves a cumulative displacement of the lens.

FIGS. 11A and 11B show another example of an annular radial actuator.

FIG. 12 shows an exploded view of a multilayer actuator.

FIG. 13 shows a front view of a multilayer annulus shaped radial actuator.

FIGS. 14A-14D show a lens structure.

FIGS. 15A and 15B assembly and radial forces within an adaptive optic lens.

FIGS. 16A and 16B show another example radial actuator.

FIG. 17 is an exploded view of a six layer circular multilayer radial actuator.

FIG. 18 is a front view of a circular multilayer radial actuator.

FIGS. 19A and 19B show a lens structure.

FIG. 20 shows modeled results for an actuator.

FIG. 21 shows calculated results as a function of displacement versus thickness ratio.

FIG. 22 shows calculated results for displacement versus thickness ratio for other material parameters.

FIG. 23 shows further calculated results

FIGS. 24A-24K show various plots as a function of different material parameters.

### DETAILED DESCRIPTION OF THE INVENTION

Examples of the invention include electromechanical polymer (EMP) actuators, in particular EMP actuators used to adjust the focus properties of a lens. An EMP actuator is an actuator including at least one layer comprising an electromechanical polymer (EMP).

Representative examples of the invention include an autofocus lens system including one or more EMP actuators. Example applications include autofocus systems for optical lenses in any camera application, including cellphone, video, digital, and miniature security cameras.

EMP actuators can be in a multilayer form, having two or more stacked EMP layers, where each layer of polymer film may be preprocessed (i.e. uniaxially stretched, electroded, etc.) to condition the layer's electromechanical response to applied external fields.

Each EMP layer has a corresponding positive and negative electrode which is used to apply the field necessary to actuate the EMP. In a multilayer form, more than one film layer with corresponding positive and negative electrodes can be stacked and bonded together in parallel. An electrode located between EMP layers may be shared between the two layers, so that each EMP layer may share one of the neighboring EMP layer's electrodes, and allowing one electrode to provide field to the film layers located each side of the electrode.

Examples of the present invention include an EMP (electromechanical polymer) autofocus camera actuator design, which is a breakthrough in miniature autofocus camera technology.

In some examples, a lens (such as a conventional rigid lens) is supported within the extensional EMP annulus. An advantage of this configuration lies in its ability to progressively stack a sequence of annular EMP actuators to achieve the desired lens extension. This modular stacking approach offers a significant design flexibility characteristic making it adaptable to a variety of extensional lengths. Such a feature is useful where the desired extensional length exceeds that achievable by any one of the annular EAP actuators.

The use of several independent annulus shaped actuators about the circumference of the lens allows the lens to be rotated about the plane of the lens, offering a tilt degree of freedom.

In some examples, a radial extension of a flexible lens is obtained, with actuation taking place within the plane of the actuator. This approach is extremely valuable where there are space limitations, for example constrained by the thickness dimension. Changes in focus can occur with no significant out of plane displacements. The use of transparent electrodes allows the change in focus of the flexible lens to be realized entirely within the footprint of the lens itself, yielding a further size reduction. In some examples, the mechanism for altering the focus of the lens is contained entirely within the geometry of the lens. As such, there exist no large complex lens deforming electromechanical structures, or the like, about the circumference of the lens consuming packaging volume.

An actuator may be mechanically coupled to the surface of a lens, for example by being bonded directly to a lens structure including the lens. The operation of the actuator may then deform the lens so as to adjust the focus of the lens. For example, an actuator may have a circular shape (e.g. a flat disk-like structure) bonded to the planar surface of a plano-convex lens, or an elastic disc attached thereto, so that a strain or stress applied to the planar surface of the lens modifies the radius of the convex surface, hence modifying the focal properties of the lens.

Electromechanical polymers find many applications in soft actuators. Although the traditional EMPs such as piezoelectric polyvinylidene fluoride (PVDF) polymers can be used to generate precise motions under an applied voltage, the electric field induced strain is very low (˜0.1% strain) and, consequently, these traditional EMPs cannot generate the motion required in the autofocus function for optical lenses. The electrostrictive P(VDF-TrFE) (TrFE: trifluoroethylene) based polymers, including terpolymers of P(VDF-TrFE-CFE) (CFE: cholorofluoroethylene) and the like, as well as the high energy particle irradiated P(VDF-TrFE), all can generate a much larger strain under an applied electric field. See for example U.S. Pat. Nos. 6,423,412, 6,605,246, and 6,787,238 for other polymers, including other VDF-based polymers, that can be used within an EMP layer.

Other example electromechanical polymers include other electroactive polymers, such as other piezoelectric polymers, including thermoplastic fluoropolymers, such as the polymers, copolymers, and terpolymers of vinylidene fluoride, and derivatives and/or blends thereof.

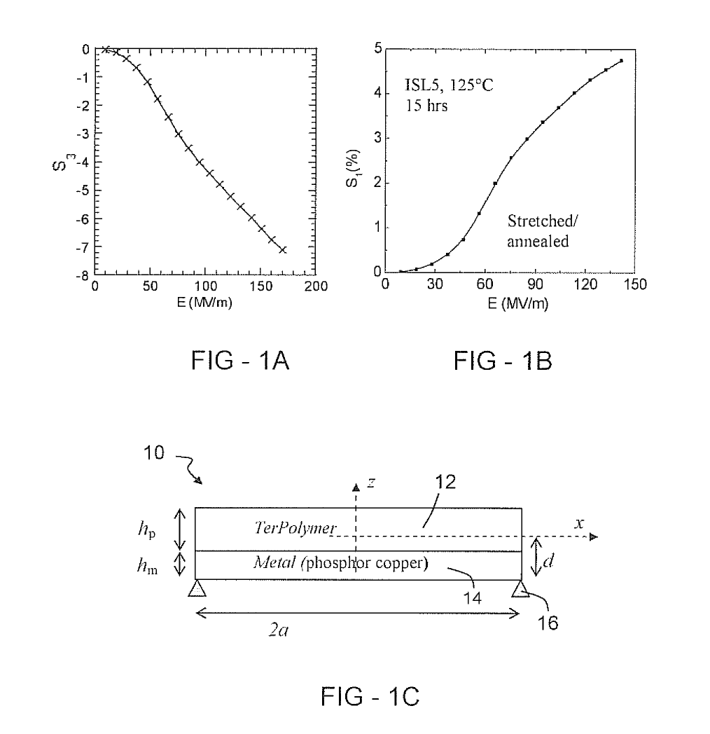

FIGS. 1A and 1B show the electromechanical response of a P(VDF-TrFE-CFE) terpolymer. FIG. 1A shows the strain of the terpolymer in the thickness direction S₃; a negative S₃ indicates the terpolymer layer becomes thinner under electric field. A thickness strain above 7% can be achieved under electric field. FIG. 1B shows the strain in the transverse direction S₁, and the film sample becomes longer if an electric field is applied across the thickness direction. A transverse strain of 4.7% can be achieved for the terpolymer.

FIGS. 1A and 1B show that a P(VDF-TrFE-CFE) electrostrictive polymer can generate a thickness strain of 7%, and a transverse strain of 5% (in the film stretch direction). Furthermore, VDF-based electromechanical polymers (EMPs, also referred to as electroactive polymers, EAPs) possess a high elastic modulus, ranging from 0.5 GPa in the uniaxially stretched P(VDF-TrFE-CFE) terpolymers to more than 1 GPa in the high energy electron irradiated P(VDF-TrFE) copolymers. The combination of high elastic modulus and high strain results in a high elastic energy density, making these EMPs unique in providing large motion with high precision for the autofocus function in optical lens applications.

FIG. 1C shows an example EMP actuator configuration, in this example a terpolymer/metal unimorph 10 comprising an electroactive polymer layer 12 and a passive layer 14. In this example, the EMP is a terpolymer and the passive layer is a metal, phosphor copper. The unimorph has a length 2a (for example=22.0 mm), width (for example) b=9.0 mm, and thickness t=hₚ+hₘ. A detailed analysis of this particular configuration is given later, illustrating the remarkably good actuation properties of this configuration. The unimorph is shown supported at both ends by support points 16. An actuator may be supported at a single location, or multiple locations.

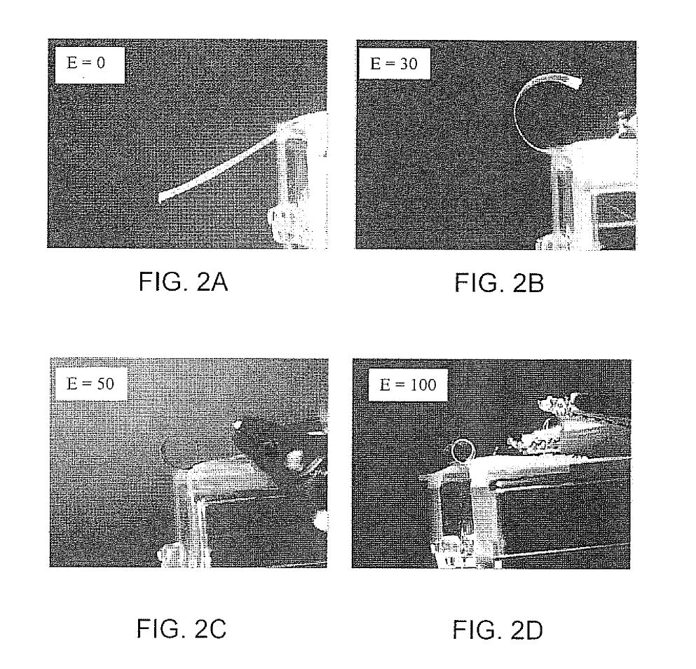

FIGS. 2A-2D show bending of an EMP unimorph actuator. The actuator is made from high energy electron irradiated P(VDF-TrFE). Applied voltages are shown in the insets. The top layer of the EMP was metalized with gold and electric field was applied on the top layer through the gold electrode. The bottom layer is a passive layer of unmetallized film. Under electric field, the top EMP layer expands in the length direction and the bottom layer does not change length, which generates the desired bending action. In FIGS. 2A-2D, different actuation states correspond to different applied electric fields. In order to keep the actuator in a given bending position, an electric field can be maintained on the EMP film.

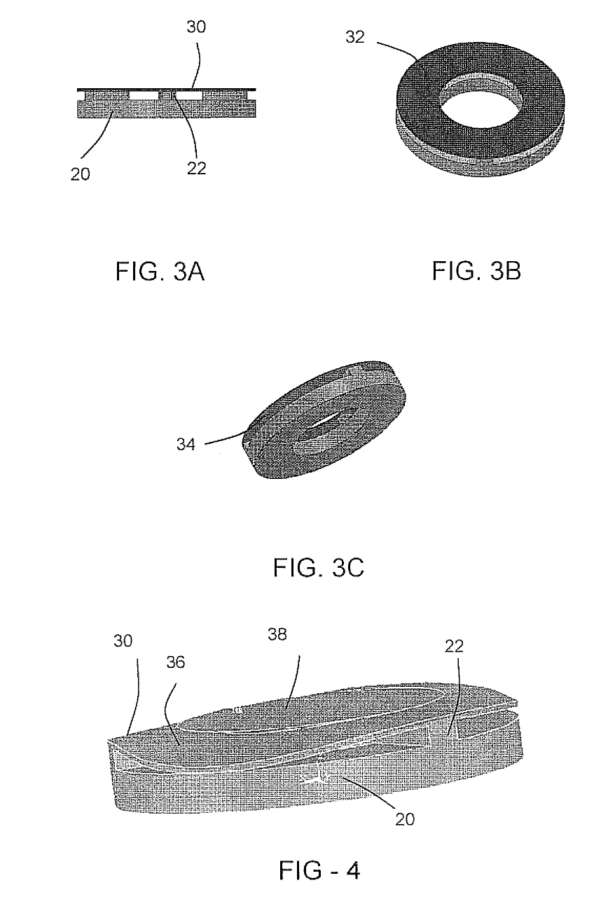

FIGS. 3A-3C illustrate an autofocus EMP actuator for an optical lens. A multilayer annulus-shaped actuator (30) is mounted on a frame (20) having actuator support pillars (22). In this example, the multilayer annulus (30) comprises an electromechanical polymer (EMP) annulus layer (32) located on a substrate annulus (passive layer 34, on the underside of the annulus). The support pillars 22 provide support points for the annulus-shaped actuator. FIG. 3A shows a side view, and FIGS. 3B and 3C show aspect views of the actuator. The term actuator here is used to refer to the annulus-shaped ring, but may also be used to refer to the combination of the annulus-shaped ring and all appropriate mechanical support components such as the frame 22. Electrodes are provided to apply an electric field to the segments of the annulus-shaped actuator.

FIG. 4 shows the predicted deflection of a multilayer electromechanical polymer annulus-shaped actuator 30, bonded to the frame (in this example, base 20) at actuator support points 22, and passive layer as detailed in FIG. 3.

The device shown in FIG. 3, when actuated as seen in FIG. 4, is fixed to the frame (22) at three actuator support points. The frame may be supported by the housing of an apparatus including the actuator. When actuated, the EMP actuator segments (36) deflect, causing displacement of an element supported by the electromechanical annulus, such as an autofocus lens 38.

The annulus-shaped actuator may be generally planar in a non-actuated state, and have an outside diameter and an inner diameter. A lens may be supported at lens support points attached to the inner diameter of the annulus shape. Application of an electric field to the actuator induces a distortion of the annulus, as shown in FIG. 4. The distortion may be a maximum in regions between the annulus support points, as shown in FIG. 4. The distortion may be either towards the base or away from it. The annulus distortion can be used to obtain an axial displacement of the lens. An axial displacement is one parallel to the optical axis of the lens, for example moving the lens towards or away from an associated imaging device. The relative positions of the frame and imaging device may be essentially fixed, so the displacements of the lens relative to the frame are also relative to the imaging device.

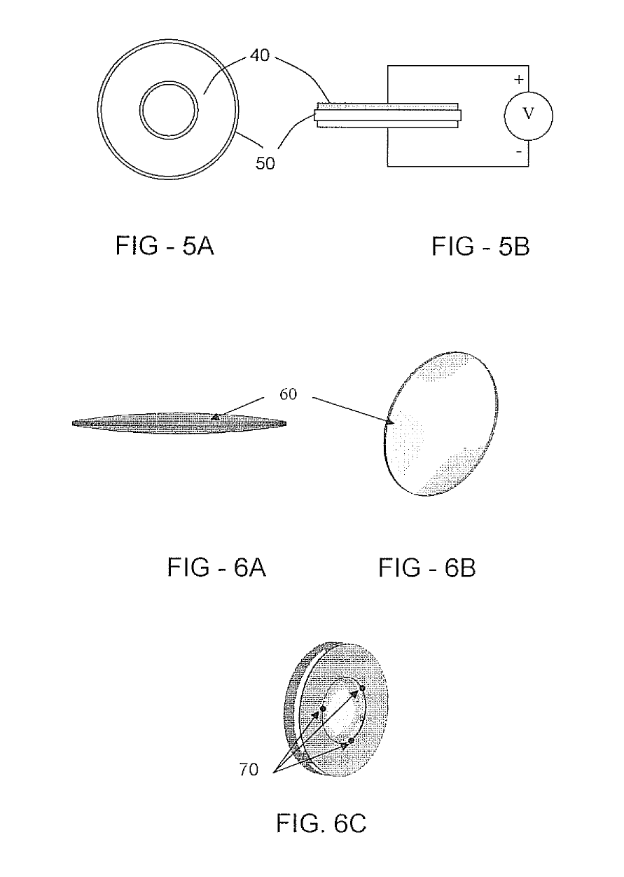

FIGS. 5A and 5B show an example electrode pattern (40) on the top and bottom of a single EMP layer (50). Both the top layer and the bottom layer are annulus patterns are concentric with the annulus shape of the EMP upon which they are bonded. FIG. 5A is a top view and FIG. 5B is a side view.

FIGS. 6A and 6B show a lens that can be supported by the electromechanical annulus, and FIG. 6C shows the lens (60) attached to the inner diameter of the electromechanical annulus at three points. These three points of attachment (70) can be at the point of largest deflection of the electromechanical annulus for any of the annulus designs.

An active EMP annulus, such as those shown in the figures, may comprise any number of electroded layer regions of EMP, preferably greater than one. These active EMP layers are distinguished from inactive EMP layers as inactive EMP layers do not have electrodes. Each active layer is electroded with a conductive material such as gold, aluminum, other metal, or conducting polymer.

Both the top and bottom layer electrodes are applied in an annulus pattern concentric with the annulus EMP material upon which they are connected, for example as shown in FIG. 5. When energized by the driving signal generator, the active EMP layers extend along their stretched axis and contract along their thickness direction. Since the axial extension of the active EMP occurs at some nonzero eccentricity from the neutral axis of the multilayer cross section, a nonzero moment is generated. This bending moment causes the annulus inner and outer circumferential edges to deflect relative to their position prior to the active EMP multilayer being energized.

An EMP-based annulus actuator may comprise one or more electroded layers of EMP. An active region of an EMP layer has electrodes, whereas an inactive EMP layer region does not have electrodes. Electrodes may comprise a conductive material, such as a metal such as gold, silver, aluminum, or other conducting material such as a semiconductor or conducting polymer. Top and bottom layer electrodes can be applied in a pattern to match the EMP regions, such as in an annulus pattern concentric with an annulus EMP.

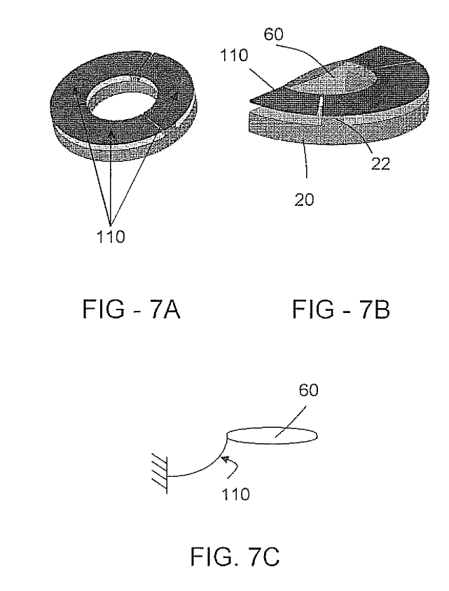

FIGS. 7A and 7B show an example configuration in which the electromechanical annulus is symmetrically divided into three segments (110). FIG. 7B shows that each segment is cantilevered from one of the three raised radial sections of the base (20). When actuated, the free end of the cantilevered segment displace upward (130) moving the autofocus lens. FIG. 7C is a simplified schematic illustrating how the actuation of the segment 110 moves the lens.

In this configuration, three cantilever segments are used to displace the lens. A multilayer electromechanical polymer can be formed in the form of bimorph actuators mounted on a frame. The number of bimorph actuators in the autofocus lens system can be two or more than two, preferably three as shown in FIG. 7A.

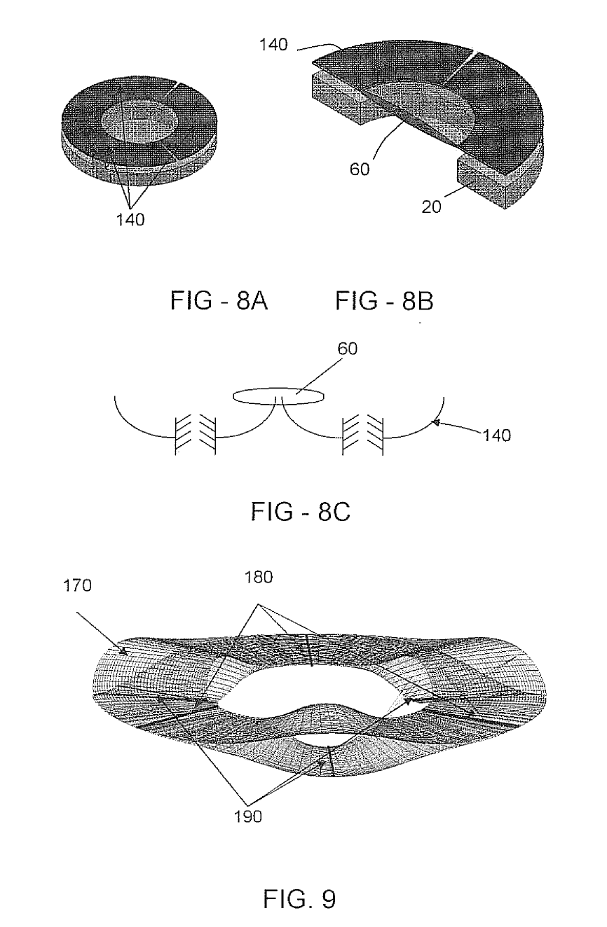

FIGS. 8A-8C show an alternate configuration of the electromechanical autofocus lens using six cantilever segments to displace the lens (60). The electromechanical annulus is symmetrically divided into three portions (140), each of which is centrally supported. The cross sectional view (FIG. 8B) shows that each segment is cantilevered from one of the three raised radial sections of the base (20). The fixed support of these cantilevered segments occurs along a radial line which bisects the electromechanical annulus portion. The resulting displacement of the electromechanical annulus segment results in a “gull wing” like shape as indicated in the simplified displacement schematic (FIG. 8C).

As illustrated by FIG. 8A-8B, a multilayer electromechanical polymer unimorph actuator mounted may be attached to a frame, such as a base. A plurality of actuations can be used, to obtain a cumulative displacement from multiple actuators. The number of multilayer EMP unimorph actuators can be two or more than two, and is preferably three. In a unimorph actuator, the multilayer EMP actuator may be bonded to a passive layer or other substrate. The substrate can be, but is not limited to, phosphor copper or a polymer, and the polymer is preferably has glass transition temperature higher than 200° C.

In another example configuration, two multilayer unimorph annuluses are bonded together along their radial length at three symmetrically positioned locations. The two bonded multilayers are bonded to the fixed base along their radial length at three symmetrically positioned locations.

FIG. 9 shows displacement of an annulus-shaped actuator (170) having three actuator support positions (180). The annulus has maximum displacement at regions between the support positions, 190. A lens can be attached to the annulus at the points of maximum displacement.

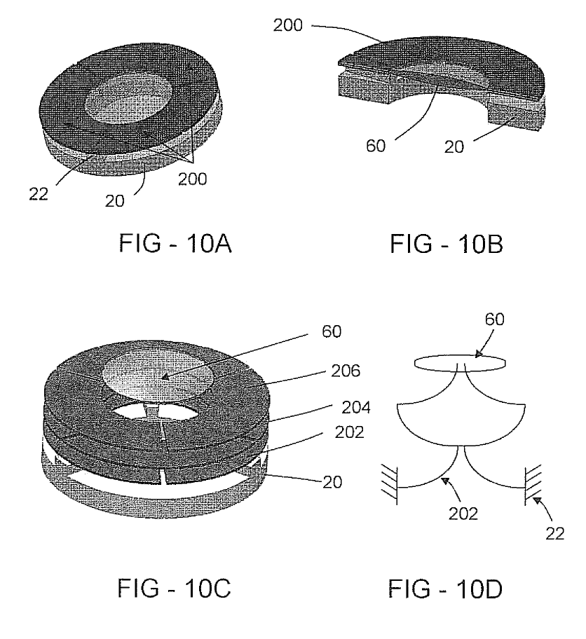

FIGS. 10A-10D show a design configuration of an active EMP annulus, and how they may be stacked together to achieve a cumulative displacement of the lens.

FIG. 10A illustrates an annulus-shaped actuator divided into three segments (200). Each segment is attached to an actuator support point at one or both ends. In this case, support pillars 22 protrude from the base 20 for use as annulus support points. On energization of the actuator, the segments 200 curve, and the displacement of the free ends of the segments relative to the base (20) can be used to obtain a lens displacement. The displacement may be in an axial direction, parallel to the optic axis of the lens, modifying the distance between the lens and an associated imaging device. The voltages applied to each segment may be approximately equal, but may be adjusted relative to each other for one or more purposes such as obtaining or eliminating a lens tilt, compensation for manufacturing variations, or any other purpose. In this example, one end of each actuator segment is free, and the free ends of the segments are the locations of maximum displacement. If both ends are attached to a support pillar, the maximum displacement is in the middle of the segment.

FIG. 10B shows the lens (60) supported within the inner radius of an annulus-shaped actuator. The lens may be attached to the actuator at lens attachment points at the free ends of the cantilevered segments 200.

FIG. 10C is an exploded view showing the orientation of the stack for each of three active electromechanical annulus (202, 204, and 206). The annulus 202 is similar to that shown as 200 in FIG. 10A, with annulus support is achieved in the middle of the segments. Each segment then has two free ends and is supported in the middle. Each successive annulus added to a stack of annuluses may be attached to a free end of a cantilevered segment of the previous annulus. The lens may be attached at the free ends of the cantilevered segments of the final annulus shaped actuator added to the stack.

FIG. 10D is a displacement schematic shows the resulting cumulative displacement using the three actuators. The fixed points correspond to the support pillars (such as 22). The curved lines illustrate curved annulus segments, on actuation.

As illustrated in FIG. 10A, the electromechanical annulus is symmetrically divided into three segments. Each segment is cantilevered from one of the three raised radial sections of the base (208). The fixed point of these cantilevered segments occurs along a radial line which bisects the electromechanical annulus segment. As such, the resulting displacement of the electromechanical annulus segment results in a “gull wing” like shape as indicated in the displacement schematic (FIG. 10D). In addition, multiple electromechanical annuluses can be stacked together, as seen in the exploded view showing three electromechanical annuluses stacked together so as to achieve a cumulative displacement, and this cumulative displacement is illustrated in the displacement schematic.

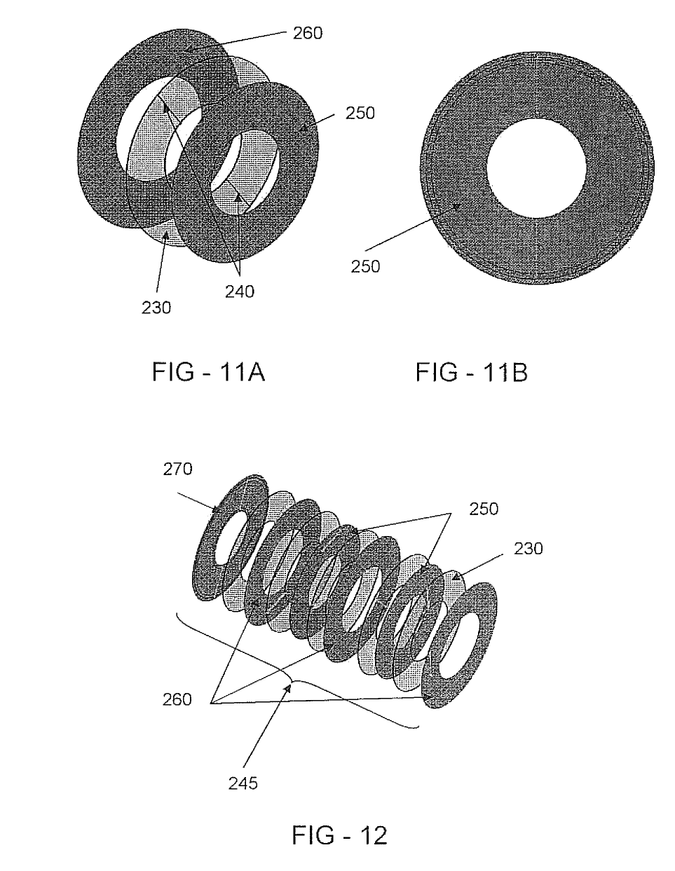

FIGS. 11A and 11B show another example of an annular radial actuator. FIG. 11A is an exploded isometric view of a single layer of the annulus shaped radial actuator showing a single layer of an annulus shaped EMP (230) with both grounding and driving signal annulus shaped electrodes (250 and 260). FIG. 11B is a front view of a single layer of the annulus shaped radial actuator.

Actuation layers comprise an annulus shaped EMP layer (230), where the uniaxially stretched direction is identified on the surface of the annulus by a line (240) for the purpose of multilayer assembly. The annulus shape allows for light to be directly incident upon the lens when collocated and concentric with the actuator.

FIG. 12 shows an exploded view of a multilayer actuator (245). A multilayer comprises alternating annular EMP (230) and electrode (250,260) layers. An EMP annulus may be electroded on one side, with a subsequent adjacent layer providing the second electrode used to drive the EMP annulus. The electrode pair includes a driving voltage electrode (250) and a corresponding ground electrode (260). In the illustrated example, the left-most layer (270) is an EMP annulus electroded on both sides.

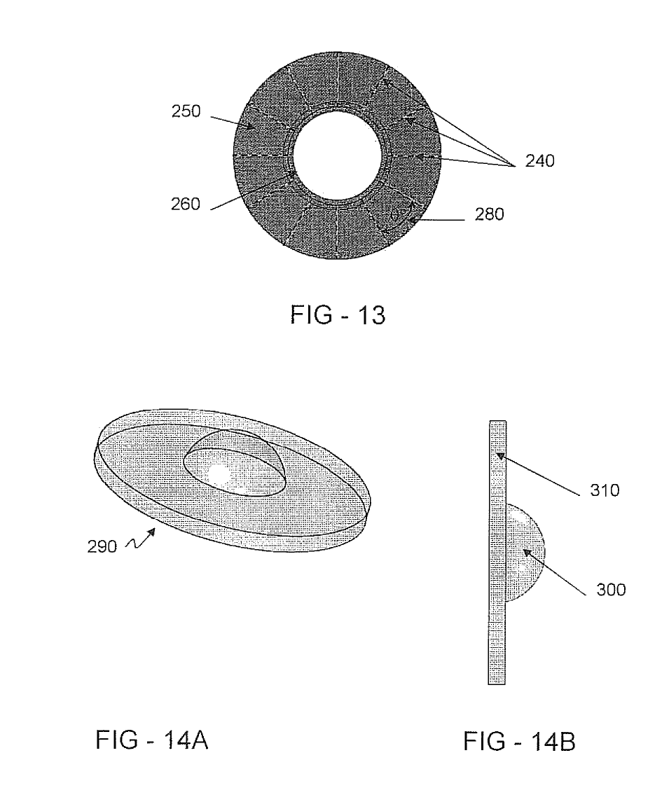

FIG. 13 shows a front view of a multilayer annulus shaped radial actuator, comprising alternating EMP and electrode annuluses. The figure shows the angular registration of the oriented directions of the annulus shaped EMP films. In this example, the stretch directions (240) of the EMP layers increment angularly by 30° going from one EMP annulus to the next one in the multilayer stack. A visible stretch direction identifier, such as a linear mark, may be used to obtain the desired angular registration between EMP layers in the concentric multilayer annular stack.

When the stack is energized, the displacement is in a radial direction. The actuation may induce a radial expansion or compression within the plane of the disk. This may be used to apply stress or strain forces on an elastic lens mechanically coupled to the actuator. A planar face of the lens may be attached to a planar face of a disk-shaped actuator.

The uniformity of the radial displacement about the circumference of the multilayer depends on the resolution of the angular registration θ. The uniformity of the angular displacement increases as the value of θ decreases. If the uniformity of the angular displacement is less important, then a larger value of θ may be used. Conversely, if the uniformity of the angular displacement is more important, then a lower value of θ may be used.

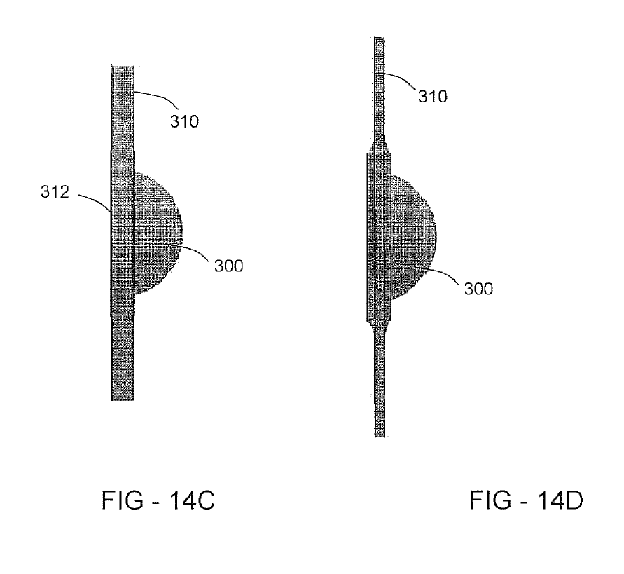

FIGS. 14A and 14B show a lens structure 290, including lens 300 and flange 310 encircling the lens. FIG. 14A shows an isometric view of the transparent elastic lens structure 290. FIG. 14B is a side view of the transparent elastic lens structure, showing more clearly the annulus shaped radial actuator bonding flange 310 and the optical lens 300.

The lens structure (290) may comprise any solid, highly elastic material such as, but not limited to, a silicone rubber or the like. The lens structure may comprise any material that is transparent and has a modulus of elasticity sufficiently low to be deformed by the actuator. The lens structure can be molded to include the lens and a large flange structure surrounding the lens.

The lens structure material can be molded to include the required lens shape (300) using a mold, where it can be allowed to cure. When cured, the lens structure (290) can be removed from the mold and the flange portion is suitable for having a radial actuator (such as 245) mounted directly on one or both sides of the flange.

FIG. 14C is a side-view of a lens structure, including lens 300 and flange 310. Annulus-shaped actuators can be placed each side of the flange, as shown at 312. Annulus-shaped radial actuators provide a radial force directed away from (or towards) the center of the flange within the plane of the generally disk-shaped flange.

FIG. 14D illustrates stretching of the flange 310. The diameter of the flange increases, and the thickness of the flange decreases within a stretched region. These forces on the flange are conveyed to the lens, as both the flange and lens are elastic and are either bonded together or formed as a unitary structure. The effect of radial forces outwards from the center of the flange slightly flattens the lens. The curvature of the curved surface of the lens is modified, having a larger radius of curvature and longer focal length as the curvature decreases. Hence, the focal length of the lens can be modified using one or more actuators mechanically coupled to the lens, either directly or through a flange or similar component of a lens structure.

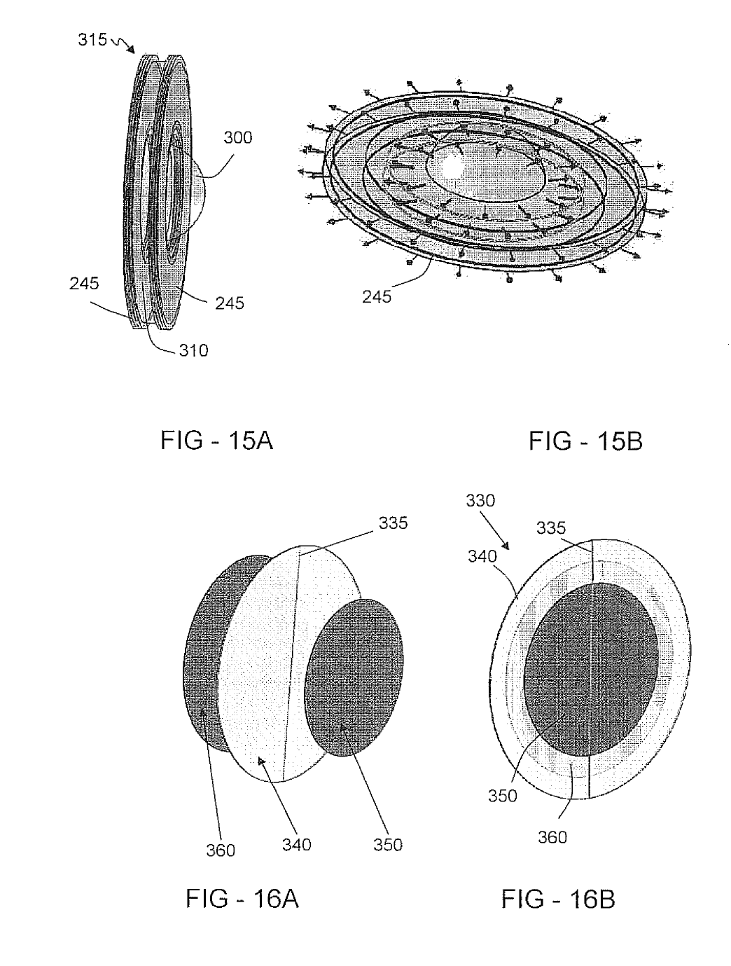

FIG. 15A shows an isometric view of a complete adaptive optic lens showing two annulus shaped multilayer radial actuators bonded to the front and back of the flange portion (310) of the lens structure. The radial actuators (245) are bonded to both sides of the flange (310) making a complete autofocus lens (315). The actuators, when energized, radially deflect the flange. The radial deflection of the flange is transferred to the lens (300) to which it is molded. This radial deflection alters the radius of curvature of the lens 300 thereby changing the focal length of the lens. The focus position is then a function of the electric field applied to the actuator. Similarly, compressive forces may be applied to the flange.

FIG. 15B shows an isometric view depicting the resultant force distribution about the circumference of the transparent elastic lens. The actuator generates radial forces, perpendicular to the optic axis of the lens, extending outwards from the center of the flange. These radial forces tend to stretch the lens away from the central axis of the lens, and hence adjust the radius of curvature of the curved lens surface. In this way, the focus position of the lens changes without a need to move the lens relative to an imaging device.

FIGS. 16A and 16B show another example radial actuator (330). FIG. 16A shows an exploded isometric view of a single layer of a circular radial actuator showing a circular EMP layer (340) with both grounding (360) and driving signal (350) circular electrodes located adjacent each side of the EMP layer.

FIG. 16B shows an isometric view of the single layer circular radial actuator (330). A stretch direction identifier (335) may be used to register the stretch direction for the layer. The radial actuator (330) comprises a circular EMP layer (340), where the uniaxially stretched direction may be identified on the surface of the circle for the purpose of assembly. The circular EMP material is electroded on both sides with circular electrodes, one electrode being the driving voltage signal electrode (350) and the other electrode being the grounding electrode (360).

The electrodes (350, 360) may be transparent electrodes. To achieve transparency as well as conductivity, the electrodes comprise a transparent conducting material, such a transparent conducting composite. An example electrode material comprises indium tin oxide (ITO) nanoparticles distributed within a polymer matrix, but other materials may be used.

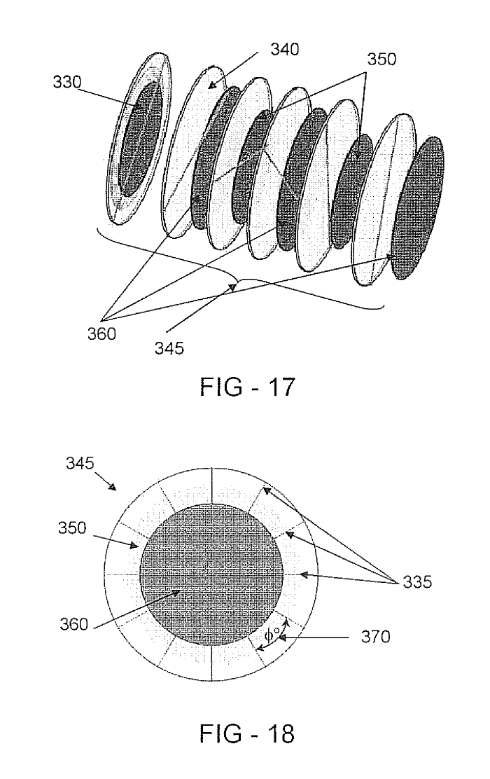

FIG. 17 is an exploded isometric view of a six layer circular multilayer radial actuator (345) with φ=30°. The actuator comprises alternating ground and driving signal circular electrodes (350, 360) as well as six circular EMP layers (340). Viewing from left to right, the multilayer comprises a structure 330 as shown in FIG. 16B, followed by alternating EMP and electrode layers. The stretch direction identifier (335) is used to register each layer in the concentric multilayer annular to the desired angular direction.

FIG. 18 shows a front view of a multilayer circular radial actuator, such as illustrated in exploded form in FIG. 17, showing the angular registration of the orientation directions (335) of the circular EMP films. When the stack is energized, the displacement is in a radial direction. The figure shows an end view of the EMP disks (340) and electrode (360).

A radial actuator may comprise a plurality of EMP layers in a multilayer stack. The stack may comprise alternating electrodes and EMP layers, each EMP layer have an electrode adjacent each side of the EMP layer. The orientation directions may be at regular angular intervals. The angular interval φ may be equal to 180° divided by the number of EMP layers.

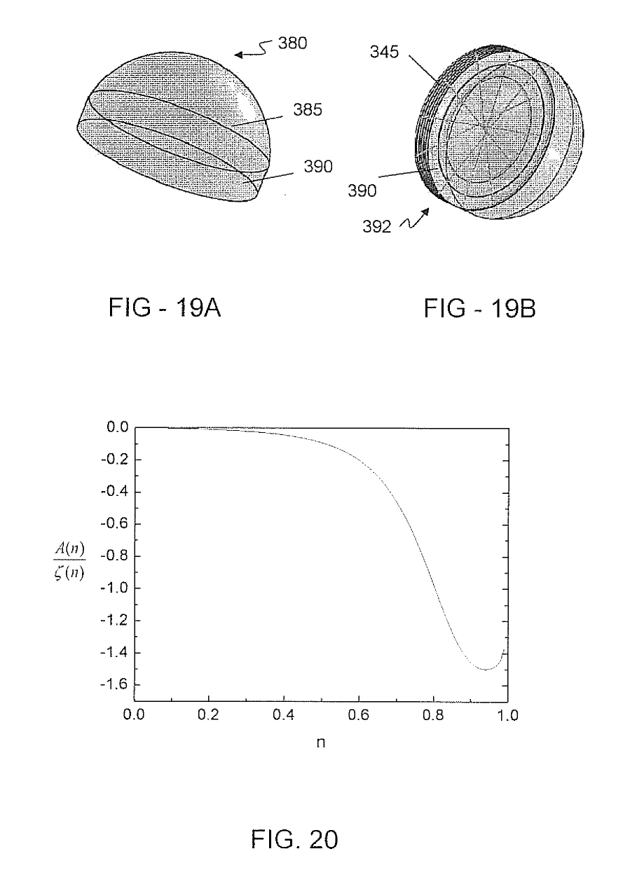

FIGS. 19A and 19B show a lens structure that can be used, for example, with the actuator of FIG. 18. FIG. 19A is an isometric view of the transparent elastic lens 380 including a plano-convex or hemispherical lens portion 380 and disk-shaped portion 390. The lens structure is without a bonding flange.

FIG. 19B is an isometric view of the complete adaptive optic lens showing one circular multilayer radial actuator 345 bonded to the back of the transparent elastic lens. The lens structure 380 is configured have the radial actuator (345) attached directly to the lens. The radial actuator 345 is bonded to the back (flat) side of the lens (380) making a complete autofocus lens (392). When energized, the actuator radially deflects, and this deflection alters the radius of curvature of the lens, thereby changing the focal length of the lens.

A lens, or lens structure including a lens, may comprise any solid, highly elastic material, and may be a silicone rubber or other material. The lens, and other portions of the lens structure within the light path, are preferably generally transparent over an operational wavelength range. The lens preferably has modulus of elasticity that is sufficiently low as to allow deformation by the actuator.

The lens structure material can be molded into the required lens shape using a mold. The lens material may be allowed to cure within the mold, and when cured, the lens structure can be removed from the mold.

Actuator Analysis

Consider the analysis for the schematic of a TerPolymer/Metal unimorph actuator shown in FIG. 1C, freely supporting at its two ends. This is a representative example and is not intended to be limiting. In this example, phosphor copper is used as a representative metal in the unimorph. In general, the passive shim layer in the unimorph can be any elastic material, for example a material which possess an elastic modulus the same or larger than that of the terpolymer.

Suppose the minimum required displacement for a cell phone camera lens autofocus is 100 micrometer under a load of 0.5 gram. The elastic properties of the materials are s_{11P}^{E}, the elastic compliance of the piezoelectric (terpolymer or similar EMP polymer) layer, and Y_{M}, the Young's modulus of the metal shim. The constitutive equations are written as:

$${S}_{1 M} = \frac{1}{{Y}_{M}} {T}_{1 M} for the metal layer , and$$

$${S}_{1 P} = {s}_{11 P}^{E} {T}_{1 P} + {d}_{31} E for the piezoelectric layer .$$

By locating the origin of coordinate system at the position of the neutral plane, the strain tensor component can be written as:

$${S}_{1} = - z \frac{{\partial }^{2} w}{\partial {x}^{2}} .$$

where w is the deflection displacement along the z axis.

$${T}_{1 M} = - {Y}_{M} z \frac{{\partial }^{2} w}{\partial {x}^{2}}$$

$${T}_{1 P} = - \frac{1}{{s}_{11 P}^{E}} z \frac{{\partial }^{2} w}{\partial {x}^{2}} - \frac{{d}_{31}}{{s}_{11 P}^{E}} E$$

The determination of the neutral plane position is carried out by calculating the stress in a cross section (the yz plane) of the laminated composite. In an elemental cross section, the stress variation versus the z coordinate is linear and the force balance needs:

$${\int }_{piezo} {T}_{1 P} d z + {\int }_{metal} {T}_{1 M} d z = 0 , ( using E = 0 )$$

$$\frac{1}{{s}_{11 P}^{E}} {\int }_{- d}^{{h}_{P} - d} z d z + {Y}_{M} {\int }_{{h}_{P} - d}^{{h}_{M} + {h}_{P} - d} z d z = 0$$

$$d = \frac{{h}_{P}}{2} + \frac{{s}_{11 P}^{E} {h}_{M} ( {h}_{M} + {h}_{P} )}{2 ( {s}_{11 P}^{E} {h}_{M} + \frac{1}{{Y}_{M}} {h}_{P} )} .$$

The bending moment produced by the stress Tₓₓ relative to y axis, is given by:

$$\begin{matrix}M = {\int }_{- d}^{{h}_{P} - d} {zT}_{1 P} d z + {\int }_{{h}_{P} - d}^{{h}_{M} + {h}_{P} - d} {zT}_{1 M} d z \\ = - D \frac{{\partial }^{2} w}{\partial {x}^{2}} - α E\end{matrix}$$

$$where$$

$$D = {D}_{P} + {D}_{M}$$

$${D}_{P} = \frac{1}{{s}_{11 P}^{E}} [ \frac{{h}_{P}^{3}}{12} + {{h}_{P} ( \frac{{h}_{P}}{2} - d )}^{2} ]$$

$${D}_{M} = {Y}_{M} [ \frac{{h}_{M}^{3}}{12} + {{h}_{M} ( \frac{{h}_{M}}{2} + {h}_{P} - d )}^{2} ]$$

$$α = \frac{{d}_{31}}{{s}_{11 P}^{E}} {h}_{P} ( \frac{{h}_{P}}{2} - d ) .$$

When neglecting the moment of inertia of the differential element, the balance of the moment requires that

$$\frac{\partial M}{\partial x} dx - Qdx = 0.$$

where Q is the shear force (along the z direction) of unit width.

$$Q = \frac{\partial M}{\partial x} = - D \frac{{\partial }^{3} w}{\partial {x}^{3}}$$

The differential equation for the bending displacement of the bilayer actuator is given by:

$$\frac{\partial Q}{\partial x} + q ( x ) = 0.$$

where q(x) is load applied on the surface of the actuator.

$$D \frac{{\partial }^{4} w}{\partial {x}^{4}} = q ( x )$$

Considering the symmetry of the actuator and boundary conditions, the solution to the above equation is:

x≧0, w(x)=C₀+C₁x+C₂x²+C₃x³

w≦0, w(x)=C₀−C₁x+C₂x²−C₃x³.

If x=0, w and

$$\frac{\partial w}{\partial x}$$

are continuous, therefore:

C₁=0.

If the actuator is simply supported at the boundary x=±a, the deflection and moment at the two ends is equal to zero, that is:

w(x=±a)=0

M(x=±a)=0.

Thus:

C₀+C₂a²+C₃a³=0

−D(2C₂+6C₃a)−αE=0.

Under a concentrated load P₀ centered at x=0, the resultant shear stress is:

$$Q = - \frac{{P}_{0}}{2 b} , ( x > 0 )$$

$$and$$

$$Q = \frac{{P}_{0}}{2 b} ( x < 0 ) .$$

thereby yielding:

$$- 6 {DC}_{3} = - \frac{{P}_{0}}{2 b} .$$

Solving these equations yields:

$${C}_{0} = \frac{{a}^{2} α E}{2 D} + \frac{{a}^{3} {P}_{0}}{6 bD}$$

$${C}_{1} = 0$$

$${C}_{2} = - \frac{α E}{2 D} - \frac{{aP}_{0}}{4 bD}$$

$${C}_{3} = \frac{{P}_{0}}{12 bD} .$$

The deflection at the center is:

$$w ( 0 ) = {C}_{0} = \frac{{a}^{2} α E}{2 D} + \frac{{a}^{3} {P}_{0}}{6 bD} . \\ If$$

$$t = {h}_{M} + {h}_{P} and n = \frac{{h}_{P}}{{h}_{M} + {h}_{P}} ( 0 < n < 1 ) , then$$

$$\begin{matrix}d = d ( t , n ) \\ = \frac{{h}_{P}}{2} + \frac{{s}_{11 P}^{E} {h}_{M} ( {h}_{M} + {h}_{P} )}{2 ( {s}_{11 P}^{E} {h}_{M} + \frac{1}{{Y}_{M}} {h}_{P} )} \\ = t \{ \frac{n}{2} + \frac{{s}_{11 P}^{E} ( 1 - n )}{2 [ {s}_{11 P}^{E} ( 1 - n ) + n / {Y}_{M} ]} \} \\ = t ξ ( n )\end{matrix}$$

$$\begin{matrix}D = D ( t , n ) \\ = \frac{1}{{s}_{11 P}^{E}} [ \frac{{h}_{P}^{3}}{12} + {{h}_{P} ( \frac{{h}_{P}}{2} - d )}^{2} ] + {Y}_{M} [ \frac{{h}_{M}^{3}}{12} + {{h}_{M} ( \frac{{h}_{M}}{2} + {h}_{P} - d )}^{2} ] \\ = {t}^{3} \{ \frac{1}{{s}_{11 P}^{E}} [ \frac{{n}^{3}}{12} + {n ( \frac{n}{2} - ξ ( n ) )}^{2} ] + {Y}_{M} [ \begin{matrix}\frac{{( 1 - n )}^{3}}{12} + ( 1 - n ) \\ {( \frac{1 - n}{2} + n - ξ ( n ) )}^{2}\end{matrix} ] \} \\ = {t}^{3} ζ ( n )\end{matrix}$$

$$\begin{matrix}α = α ( t , n ) \\ = \frac{{d}_{31}}{{s}_{11 P}^{E}} {h}_{P} ( \frac{{h}_{p}}{2} - d ) \\ = {d}_{31} {t}^{2} [ \frac{1}{{s}_{11 P}^{E}} n ( \frac{n}{2} - ξ ( n ) ) ] \\ = {d}_{31} {t}^{2} A ( n )\end{matrix}$$

$$\begin{matrix}w ( 0 ) = \frac{{a}^{2} α E}{2 D} + \frac{{a}^{3} {P}_{0}}{6 bD} \\ = \frac{{a}^{2} {d}_{31} E}{2 t} \frac{A ( n )}{ζ ( n )} + \frac{{a}^{3} {P}_{0}}{6 {bt}^{3} ζ ( n )}\end{matrix}$$

FIG. 20 shows calculated results. For the material properties: piezoelectric layer: PVDF s_{11P}^{E}=2×10⁻⁹, and the metal shim (passive layer): phosphor copper Y_{M}=1.23×10¹¹, and the geometry of the actuator: 2a=22 mm, b=9 mm, and a concentrated load: P₀=5×10⁻³ N, the calculated results showed that the thickness ratio n for the terpolymer layer is preferably less 0.6.

Consider now a case study showing parametric variations of the actuator geometry and material properties. This study helps to show that the actuator has the displacement and load carrying ability to meet the autofocus displacement and load requirements. The examples describe use of a terpolymer EMP, but any suitable polymer may be used.

Case I:

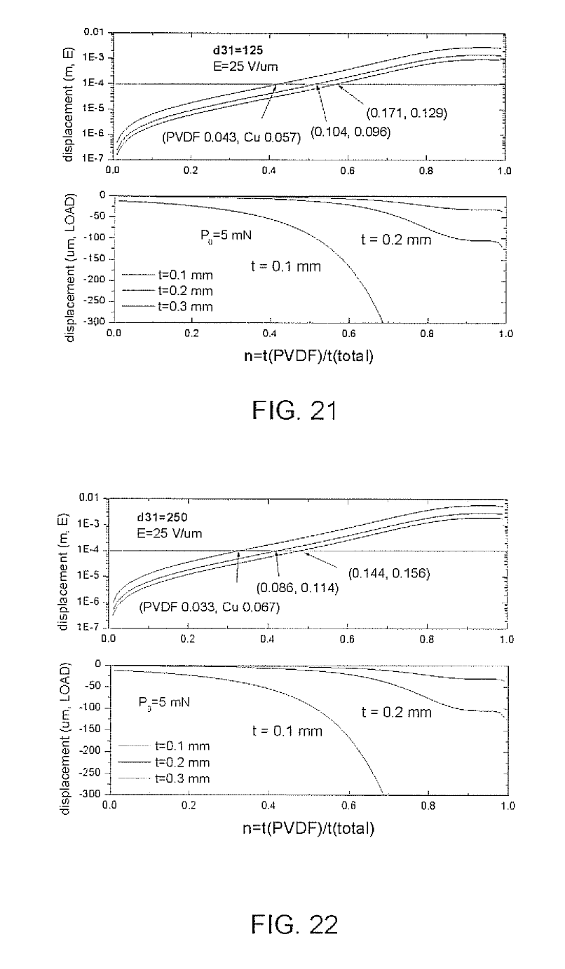

FIG. 21 shows further calculated results for displacement versus thickness ratio. Supposing that d₃₁=125 pm/V, this plot suggests that the thickness ratio for the terpolymer layer is preferably higher than 0.43 for t(total thickness)=0.1 mm; 0.52 for t(total thickness)=0.2 mm: and 0.57 for t(total thickness)=0.3 mm. From the load curve, the t(total thickness)=0.2 mm is stiffness enough for resisting a 0.5 gram load.

Case II:

FIG. 22 shows calculated results for displacement versus thickness ratio for other material parameters. Supposing now that d₃₁=250 pm/V, the results suggest that the thickness ratio for the terpolymer layer is preferably higher than 0.33 for t(total thickness)=0.1 mm; 0.43 for t(total thickness)=0.2 mm; and 0.48 for t(total thickness)=0.3 mm. From the load curve, the t(total thickness)=0.1 mm may have enough stiffness for resisting a 0.5 gram load.

Case III:

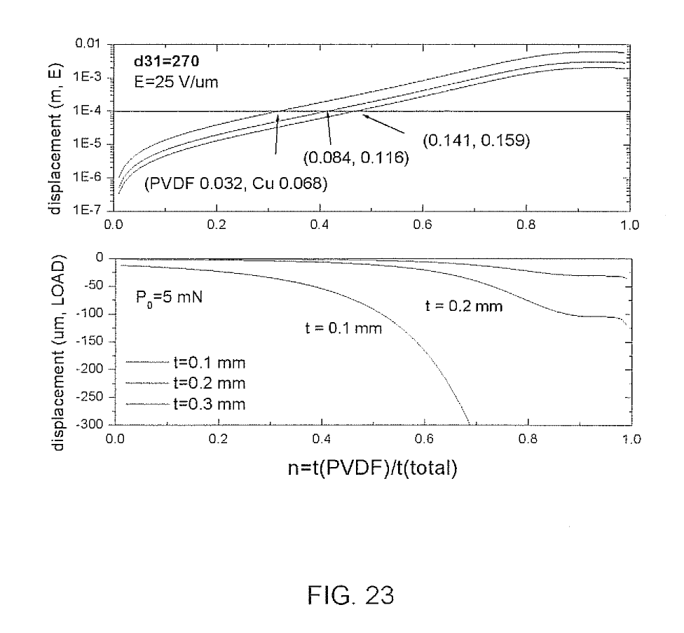

Supposing that d₃₁=270 pm/V, FIG. 23 suggests that the thickness ratio for the terpolymer layer is preferably higher than 0.32 for t(total thickness)=0.1 mm; 0.42 for t(total thickness)=0.2 mm; and 0.47 for t(total thickness)=0.3 mm. From the load curve, the t(total thickness)=0.1 mm may have enough stiffness for resisting a 0.5 gram load.

Therefore, if d₃₁ can be 250 pm/V, the thickness of the terpolymer layer can be 0.04 mm, and the thickness of metal layer (phosphor copper) can be 0.07 mm. The required working voltage is 25V per micrometer.

Calculated Values for Passive Shims of Different Young's Modulus:

The examples below illustrate how the Young's modulus of the passive shim influences the unimorph performance.

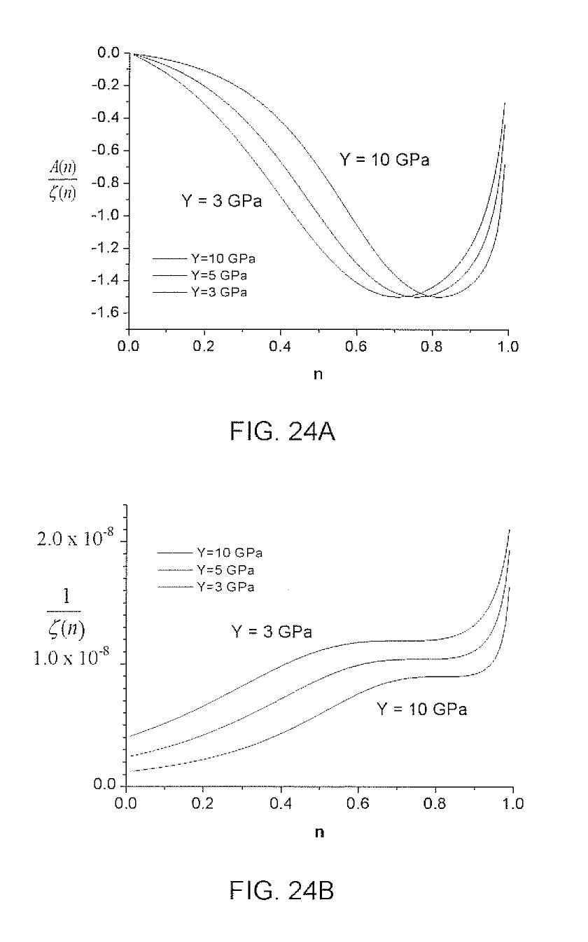

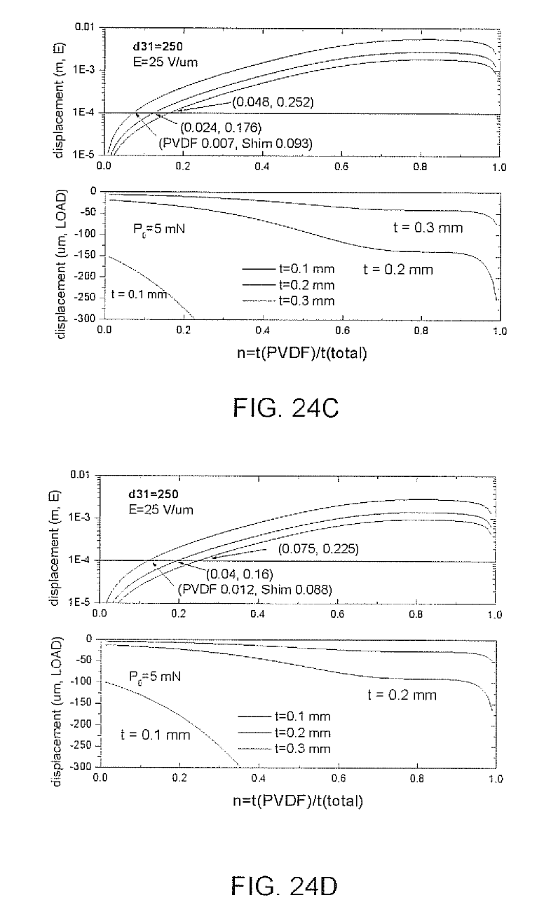

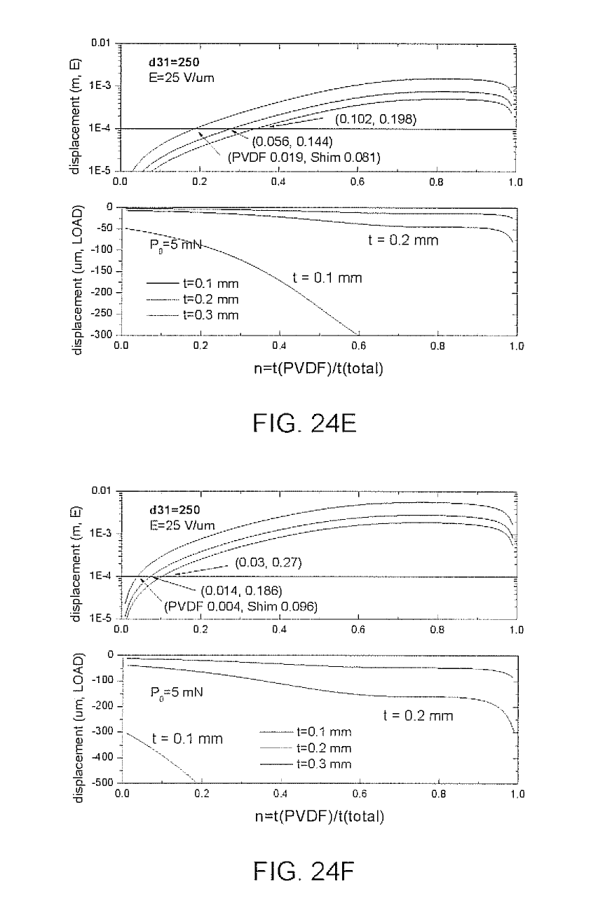

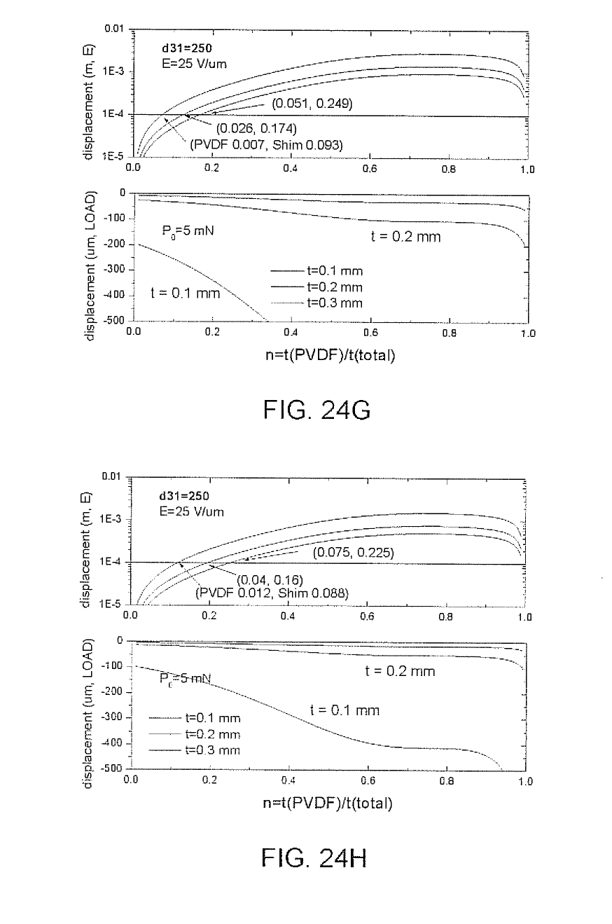

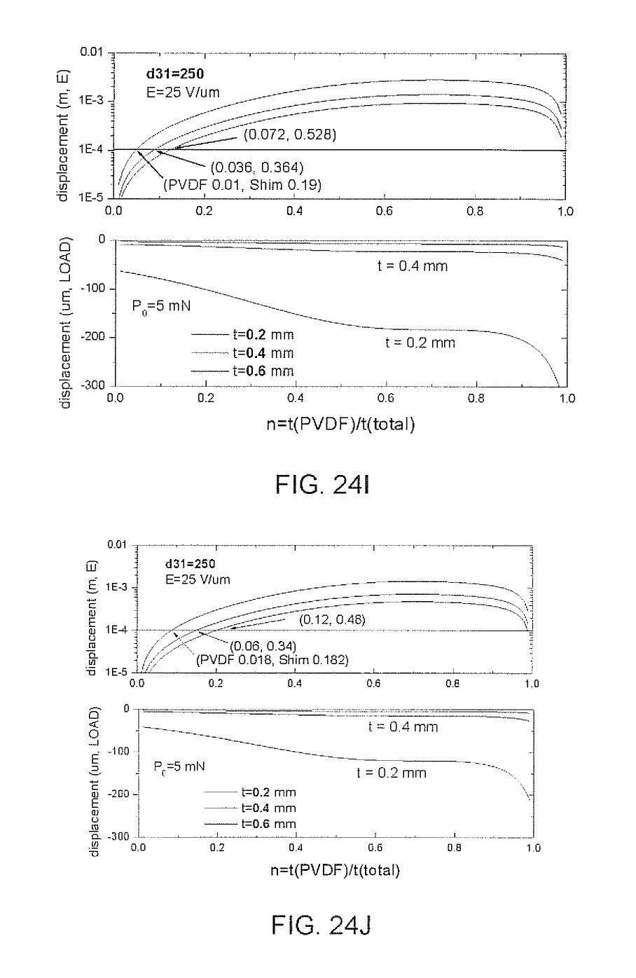

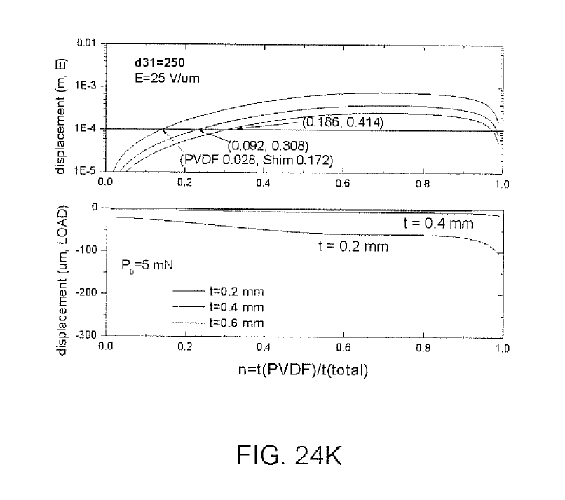

FIGS. 24A-24K show various plots as a function of different material parameters.

FIG. 24A shows values of

$$\frac{A ( n )}{ζ ( n )}$$

for piezoelectric layer: PVDF s_{11P}^{E}=2×10⁻⁹: Passive shim: Y=10, 5, 3 GPa.

FIG. 24B shows calculated values of

$$\frac{1}{ζ ( n )}$$

: Piezoelectric layer: PVDF s_{11P}³=2×10⁻⁹: Passive shim: Y=10, 5, 3 GPa.

FIGS. 24C-24E show material properties for Piezoelectric layer: PVDF s_{11P}^{E}=2×10⁻⁹, Passive shim: Y=10 GPa. For each figure, the dimension of the actuator are as follows:

FIG. 24C 2a=22 mm, b=9 mm

FIG. 24D 2a=15.7 mm, b=5.0 mm

FIG. 24E 2a=11.5 mm, b=4.0 mm

Concentrated load: P₀=5×10⁻³ N

FIGS. 24F-24H show material properties for Piezoelectric layer: PVDF s^{11P}^{E}=2×10⁻⁹, Passive shim: Y=5 GPa, Dimension of the actuator:

FIG. 24F 2a=22 mm, b=9 mm

FIG. 24G 2a=15.7 mm, b=5.0 mm

FIG. 24H 2a=11.5 mm, b=4.0 mm

Concentrated load: P₀=5×10⁻³ N

FIGS. 24I-K show material properties for Piezoelectric layer: PVDF s_{11P}^{E}=2×10⁻⁹, Passive shim: Y=3 GPa. Dimension of the actuator:

FIG. 24I 2a=22 mm, b=9 mm

FIG. 24J 2a=15.7 mm, b=5.0 mm

FIG. 24K 2a=11.5 mm, b=4.0 mm

Concentrated load: P₀=5×10⁻³ N

Further Discussion of Electromechanical Polymers (EMPs)

Example electromechanical polymers, which may be used in layer form in actuators according to examples of the present invention, can be selected from P(VDFₓ-TrFE_{y}-CFE_{1-x-y}) (CFE: chlorofluoroethylene), P(VDFₓ-TrFE_{y}-CTFE_{1-x-y}) (CTFE: chlorotrifluoroethylene), poly(vinylidene fluoride-trifluoroethylene-vinylidede chloride) (P(VDF-TrFE-VC)), poly(vinylidene fluoride-tetrafluoroethylene-chlorotrifluoroethylene) (P(VDF-TFE-CTFE)), poly(vinylidene fluoride-trifluoroethylene-hexafluoropropylene), poly(vinylidene fluoride-tetrafluoroethylene-hexafluoropropylene), poly(vinylidene fluoride-trifluoroethylene-tetrafluoroethylene), poly(vinylidene fluoride-tetrafluoroethylene-tetrafluomethylene), poly(vinylidene fluoride-tri fluoroethylene-vinyl fluoride), poly(vinylidene fluoride-tetrafluoroethylene-vinyl fluoride), poly(vinylidene fluoride-trifluoroethylene-perfluoro(methyl vinyl ether)), poly(vinylidene fluoride-tetrafluoroethylene-perfluoro(methyl vinyl ether)), poly(vinylidene fluoride-trifluoroethylene-bromotrifluoroethylene, polyvinylidene), poly(vinylidene fluoride-tetrafluoroethylene-chlorofluoroethylene), poly(vinylidene fluoride-trifluoroethylene-vinylidene chloride), and poly(vinylidene fluoride-tetrafluoroethylene vinylidene chloride), or in a general form of P(VDFₓ-2nd monomer_{y}-3rd monomer_{1-x-y}) where x can be in the range from 0.5 to 0.75, y in the range 0.45 to 0.2. Further examples are given in U.S. Pat. No. 6,787,238, which is incorporated by reference.

In some examples of the present invention, any electromechanical material can be used. If the actuator is located in the light path for light passing through the lens to a detector, the actuator is preferably transparent or substantially transparent to the light. Any electrode/electromechanical material combination can be used that allows a combination of actuation and transparency.

An electromechanical polymer can be selected from the high energy irradiated P(VDFₓ-TrFE₁₋ₓ) copolymers, in particular where x can be varied from 0.5 to 0.75.

Example materials include those described in U.S. Pat. Nos. 6,423,412 and 6,605,246, both of which are incorporated by reference.

An electromechanical polymer can be in the form of a polymer blend. Example polymer blends include of polymer blends of the terpolymer described above with any other polymers.

Electromechanical polymer films can be uniaxially stretched, and in fabricating the EMP actuator, the uniaxial stretching direction may be along the circumferential direction of the actuator. In other examples, the electromechanical polymer films can be in a non-stretched form. In other examples, the electromechanical polymer films can be biaxially stretched.

Further Example Aspects

Examples of the present invention include a multilayer electromechanical polymer (EMP) actuator driven autofocus lens system. A multilayer EMP actuator may include one or more EMP layers, and may also include one or more passive layer(s).

A multilayer electromechanical polymer actuator may be in the shape of an annulus. Examples may include a passive shim annulus upon which a multilayer electromechanical polymer annulus is bonded.

In some examples, an actuator comprises an EMP layer adjacent a passive shim annulus, or other passive layer. Example materials for passive layers include a metal, such as phosphor copper or other metal, or a polymer, where the polymer preferably has a glass transition temperature higher than 200° C.

Example apparatus may further comprise a frame, e.g. upon which an actuator (such as an actuator including a multilayer electromechanical polymer annulus) is bonded.

Another example device comprises a multilayer electromechanical polymer actuator in the shape of bimorph actuators mounted on a frame, such as illustrated in FIGS. 7 and 8.

The number of bimorph actuators in an autofocus lens system can be one or more, preferably two or more, and in some preferred examples is three or more (for example, as illustrated in FIG. 10C).

An example unimorph actuator may include a multilayer EMP bonded to a passive layer or substrate.

Substrate materials may comprise a metal, such as phosphor copper, or a polymer. In some examples, the polymer is preferably has glass transition temperature higher than 200° C.

An example EMP actuator includes an electromechanical polymer (EMP), which may also be referred to as an electroactive polymer (EMP), in the form of a layer which may be bonded or otherwise attached to a passive layer. An EMP layer may be a single layer or a polymer multilayer. In some examples, the EMP layer or film is a uniaxial or biaxial film, or otherwise oriented to some degree, formed by e.g. stretching, other mechanical deformation or treatment, through the application of fields such as electric or magnetic fields, or other treatment. In an annular film, the axis of a uniaxial film (or one axis of a biaxial film) may be generally circular around the annulus (circumferential).

A mechanical response in an actuator may occur due to the different electromechanical responses (e.g. different in magnitude and/or direction of electromechanical response) for different layers within a multilayer film, on the application of an electric field. For example, application of a field may induce a mechanical extension or constriction of an EMP layer in a certain direction, and no (or appreciably less) mechanical response in another layer, such as a passive layer, in the same direction. A passive layer may be a metal, polymer, or other material. The passive layer may be a flexible film. The passive layer may be generally non-electroactive, non-piezoelectric, and/or have an electromechanical response at least one order of magnitude less than the EMP layer.

An EMP actuator may comprise one or more electroactive polymers in adjacent layers. For example, an actuator may comprise two thin EMP films, such as two P(VDF-TrFE-CFE) polymer films bonded together, so that when an electric field is applied to one terpolymer film it becomes longer, thereby creating a bending motion.

In some examples, a surface of a radial actuator may be used to support a droplet of liquid, such as an approximately hemispherical droplet. The droplet shape and hence optical properties may be varied as a function of actuation.

In some examples, actuators may be used to control optical properties of other optical elements. For example, the spacing of a grating may be electronically controlled, for example by attaching a grating element to a radial element.

In some examples, an actuator may be used to control color, for example of a pixel element, or to switch an optical element between transmission and non-transmission. Applications include displays, such as electronic books and the like.

A multilayer actuator element may include a multilayer structure, at least one pair of adjacent layers having a piezoelectric coefficient (such as d₃₁) differing by at least one order of magnitude, and in some examples by at least two orders of magnitude. A multilayer actuator element may include at least one pair of adjacent layers in the form of a piezoelectric polymer adjacent to (e.g. bonded to) a non-piezoelectric layer, such as a metal layer or non-piezoelectric polymer layer, or other layer having no appreciable piezoelectric response.

In some examples, an actuator element may be non-planar or otherwise deformed with no field applied, and achieve a planar configuration on application of an electric field.

If flexible and planar faced GRIN type lenses are used, then several transparent electrode actuators laminated to a flexible GRIN lens can be stacked in series to create a continuous length structure capable of altering its index of refraction continuously along its length.

Any configuration used as an actuator may in other examples be used as a sensor, or may have a combination of sensor and actuator functions. An electrical signal may be detected from the electrodes in response to a mechanical signal, such as a vibrational signal, strain, stress, and the like.

In some examples, the lens may be a generally rigid lens that is moved, relative to a frame, so as to adjust a focus position of the lens. The lens material may be glass, optical plastic, or any material that is generally transparent at the wavelength ranges of interest. In other examples, the lens may be deformable or otherwise have a focal length that may be adjusted using an actuator, enabling the lens focus to be adjusted without physical movement of the lens.

Examples of the invention further include any apparatus including an adjustable focus lens (or a plurality thereof), such as a camera, microscope, artificial eye component, adaptive optics devices (including telescopes and the like), imaging arrays, optical routers and other optical control components, and display devices such as an improved three-dimensional television. Apparatus may include an array of adjustable focus lenses, for 2D and/or 3D imaging and/or display applications. Apparatus may also include miniature cameras for security applications.

An example improved autofocus device may include an imaging sensor, a focus sensor (which may be the imaging sensor), an electronic circuit (control circuit), an actuator, and a lens. The focus sensor passes a signal to the control circuit, which determines the appropriate focus for the lens, for example in terms the separation distance between the lens and the imaging sensor and/or the focal length of the lens. The control circuit then provides the appropriate voltage signal (which may include one or more applied voltage levels) to the actuator so as to obtain the appropriate focus. In some examples, the lens focus position may be scanned, by varying the voltage signal to the actuator, and the appropriate focus position determined during the scan.

Examples of the invention further include any apparatus including an actuator according to examples herein, and include microactuation devices, artificial muscles, and the like.

Other examples include actuators for any other applications, adaptive optics (e.g. adjustable mirror arrays), other adjustable reflective arrays, actuators comprising two or more electromechanical polymer layers bonded together having different electromechanical properties (e.g. different magnitudes and/or directions of EMP response), sensors which convert deformation of e.g. an EMP/passive layer structure into electrical signals, combination sensor/actuator structures, various configurations of interconnected actuators, autofocus for any imaging device and/or projection device, arrays of autofocus elements for 3D applications, and the like.

Patents or publications mentioned in this specification are herein incorporated by reference to the same extent as if each individual publication was specifically and individually indicated to be incorporated by reference.

The invention is not restricted to the illustrative examples described above. Examples described are not intended to limit the scope of the invention. Changes therein, other combinations of elements, and other uses will occur to those skilled in the art. The scope of the invention is defined by the scope of the claims.

Having described our invention, we claim:

1. An apparatus, the apparatus being an adjustable focus apparatus comprising:
an actuator including:
an electromechanical polymer (EMP) layer;
electrodes configured to apply an electric field across an active portion of the EMP layer, the electric field inducing an electromechanical response in the actuator; and
a lens, mechanically coupled to the actuator,
the electromechanical response of the actuator adjusting a focus of the lens.

2. The apparatus of claim 1, the actuator including having a multilayer structure including a plurality of EMP layers.

3. The apparatus of claim 1, the electrodes comprising a metal, an electrically conducting oxide, or electrically conducting polymer layer,
the electrodes having a thickness of less than 100 μm.

4. The apparatus of claim 3, the electrodes comprising indium tin oxide (ITO).

5. The apparatus of claim 1, further comprising a frame supporting the actuator, the electromechanical response of the actuator moving the lens relative to the frame.

6. The apparatus of claim 1, the EMP layer being adjacent a passive layer, the passive layer having no appreciable electromechanical response.

7. The apparatus of claim 1, the actuator having an annulus shape,
the actuator being mechanically connected to the lens at one or more lens attachment points,
the lens being supported within an inner radius of the annulus shape.

8. The apparatus of claim 7, the actuator being supported by a frame at a plurality of actuator support points,
the lens attachment points being located between the actuator support points.

9. The apparatus of claim 7, the annulus shape being divided a plurality of segments,
each segment including an active portion of the EMP layer and being supported by an actuator support point.

10. The apparatus of claim 7, the lens attachment points being located adjacent active portions of the EMP layer within the annulus shape.

11. The apparatus of claim 7 the apparatus having three lens attachment points and three frame support points.

12. The apparatus of claim 7, the actuator being operational to move the lens axially when the actuator is energized.

13. The apparatus of claim 1, the actuator being operable to produce a mechanical deformation of the lens,
the lens including an elastic solid material,
the mechanical deformation of the lens adjusting the focus of the lens.

14. The apparatus of claim 13, the actuator inducing a radial force on the lens when the actuator is energized, the radial force being perpendicular to an optic axis of the lens.

15. The apparatus of claim 13, the apparatus including a lens structure, the lens being part of the lens structure,
the lens structure having a surface attached to the actuator,
the actuator providing a force along the surface when the actuator is energized.

16. The apparatus of claim 15, the actuator having a generally annular form,
the lens structure including a flange disposed around the circumference of the lens,
the actuator being attached to the flange, the lens being supported within an inside radius of the annular form.

17. The apparatus of claim 15, the lens structure comprising a multilayer of different transparent elastic solids.

18. The apparatus of claim 15, the lens structure providing a flat surface, the flat surface being bonded to the actuator.

19. The apparatus of claim 18, the actuator having a generally disk-shaped form, a surface of the disk-shaped form being attached to the flat surface of the lens structure.

20. The apparatus of claim 19, the lens focusing light passing through the lens,
at least some of the light passing through the lens also passing through the actuator,
the lens and actuator both being generally transparent to the light.

21. The apparatus of claim 1, the EMP layer having a stretching direction,
the electromechanical polymer layer extending in the direction of the stretching direction on application of the electric field.

22. The apparatus of claim 1, the EMP layer having uniaxial or biaxial orientation.

23. The apparatus of claim 1, the EMP layer being a relaxor ferroelectric polymer.

24. The apparatus of claim 23, the relaxor ferroelectric polymer being a polymer, copolymer, or terpolymer of vinylidene fluoride.

25. The apparatus of claim 23, the EMP layer comprising at least one polymer selected from a group of polymers consisting of:
P(VDFₓ-TrFE_{y}-CFE_{1-x-y}) (CFE: chlorofluoroethylene), P(VDFₓ-TrFE_{y}-CTFE_{1-x-y}) (CTFE: chlorotrifluoroethylene), Poly(vinylidene fluoride-trifluoroethylene-vinylidede chloride) (P(VDF-TrFE-VC)), poly(vinylidene fluoride-tetrafluoroethylene-chlorotrifluoroethylene) (P(VDF-TFE-CTFE)), poly(vinylidene fluoride-trifluoroethylene-hexafluoropropylene), poly(vinylidene fluoride-tetrafluoroethylene-hexafluoropropylene), poly(vinylidene fluoride-trifluoroethylene-tetrafluoroethylene), poly(vinylidene fluoride-tetrafluoroethylene-tetrafluoroethylene), poly(vinylidene fluoride-tri fluoroethylene-vinyl fluoride), poly(vinylidene fluoride-tetrafluoroethylene-vinyl fluoride), poly(vinylidene fluoride-trifluoroethylene-perfluoro(methyl vinyl ether)), poly(vinylidene fluoride-tetrafluoroethylene-perfluoro (methyl vinyl ether)), poly(vinylidene fluoride-trifluoroethylene-bromotrifluoroethylene, polyvinylidene), poly(vinylidene fluoride-tetrafluoroethylene-chlorofluoroethylene), poly(vinylidene fluoride-trifluoroethylene-vinylidene chloride), and poly(vinylidene fluoride-tetrafluoroethylene vinylidene chloride), and P(VDFₓ-2^{nd} monomer_{y}-3^{rd} monomer_{1-x-y}) where x is in the range from 0.5 to 0.75, y in the range 0.45 to 0.2.

26. The apparatus of claim 23, the EMP being a high energy irradiated P(VDFₓ-TrFE₁₋ₓ) copolymer, where x is between 0.5 and 0.75, inclusive.

27. An electronic device including an autofocus camera, the autofocus camera including the apparatus of claim 1,
the electronic device being a cellphone, digital camera, or video camera.
